(19) United States
(12) Patent Application Publication
(10) Pub. No.: US 2026/0188893 A1
(43) Pub. Date: Jul. 2, 2026

(54) BASE STATION ANTENNA AND MULTI-FREQUENCY BAND ANTENNA

(71) Applicant: Outdoor Wireless Networks LLC, Richardson, TX (US)

(72) Inventors: Pengfei Guo, Suzhou (CN); Changfu Chen, Suzhou (CN); Bin Sun, Suzhou (CN); Cheng Xue, Suzhou (CN); Jian Zhang, Suzhou (CN)

(21) Appl. No.: 19/408,451

(22) Filed: Dec. 4, 2025

(30) Foreign Application Priority Data
Dec. 27, 2024 (CN) 2024119475097

(51) Int. Cl. H01Q 1/24; H01Q 19/10; H01Q 21/06

(52) U.S. Cl. CPC H01Q 1/246; H01Q 19/10; H01Q 21/06

(57) ABSTRACT

A base station antenna comprises a reflective plate, first and second columns of radiating elements, and at least one first decoupling metamaterial element positioned between the first and second columns. The first decoupling metamaterial element is mounted behind radiators of the first radiating elements and configured to at least partially reduce coupling between the radiating elements in the first and second columns. A major surface of the first decoupling metamaterial element is substantially parallel to a major surface of the reflective plate.

### CROSS-REFERENCE TO RELATED APPLICATION

The present application claims priority to Chinese Patent Application No. 202411947509.7, filed Dec. 27, 2024, the entire content of which is incorporated herein by reference as if set forth fully herein.

### FIELD

The present disclosure relates to a communication system, and more particularly relates to a base station antenna, for example, a multi-frequency band antenna, suitable for the communication system.

### BACKGROUND

Cellular communication systems are well known in this field. In a typical cellular communication system, a geographic area is divided into a series of regions that are referred to as “cells”, and each cell is served by a base station. The base station may comprise baseband equipment, a radio transceiver device, and a base station antenna, which is configured to provide two-way radio frequency (“RF”) communication for subscribers positioned throughout the cell. In many cases, the cell may be divided into a plurality of “sectors” in the azimuth plane, and separate base station antennas provide coverage for each sector. Base station antennas are often mounted on towers or other raised structures, and radiation patterns generated by each antenna (“antenna beams”) are directed outwardly from the antennas to service respective sectors. Usually, the base station antenna comprises one or more phased arrays of radiating elements, and when the antenna is installed and used, the radiating elements are arranged in one or more vertical columns. “Vertical” herein refers to a direction perpendicular to a plane defined by a horizon.

A common base station configuration is a “three-sector” configuration, where the cell is divided into three 120° sectors in the azimuth plane, and the base station can comprise at least three base station antennas that provide coverage for the three respective sectors. The azimuth plane refers to a horizontal plane that bisects the base station antenna and is parallel to the plane defined by the horizon. In a three-sector configuration, antenna beams generated by each base station antenna typically have a half-power beam width (“HPBW”) of approximately 65° in the azimuth plane, such that the antenna beams provide good coverage within all three 120° sectors. Typically, each base station antenna comprises a linear array of radiating elements that extend vertically, and these radiating elements together generate the antenna beams. Each radiating element in the column may have an HPBW of approximately 65°, such that the antenna beams generated by the linear array of the radiating elements will cover the 120° sectors in the azimuth plane.

In order to accommodate the ever-increasing volume of cellular communications, cellular operators have added cellular services in a variety of new frequency bands. In some cases, it is possible to use so-called “wide band” or “ultra-wide band” radiating element arrays to provide service in a plurality of frequency bands, but in other cases, it is necessary to use different radiating element arrays to support service in different frequency bands.

As the number of frequency bands has proliferated, increased sectorization has become more common (e.g., dividing a cell into six, nine or even twelve sectors), and the number of base station antennas deployed at a typical base station has increased significantly. However, due to local zoning ordinances and/or weight and wind loading constraints for the antenna towers, etc. there is often a limit as to the number of base station antennas that can be deployed at a given base station. In order to increase capacity without further increasing the number of base station antennas, so-called multi-frequency band antennas have been introduced in which a plurality of arrays of radiating elements are included in a single antenna. A very common multi-frequency band antenna includes a “low-frequency band” radiating element array that is used for providing service in some or all of 617-960 MHz frequency bands, and a “mid-frequency band” radiating element array that is used for providing service in some or all of 1427-2690 MHz frequency bands. These low-frequency band and mid-frequency band radiating element arrays are typically mounted in a side-by-side mode.

There is also great interest in multi-frequency band antennas that include, for example, two columns of low-frequency band radiating elements and four columns of mid-frequency band radiating elements. These antennas may be used in various applications, including multiple-input and multiple-output (“MIMO”) applications, or may be used as multi-frequency band antennas having two different low-frequency bands (for example, 700 MHz low-frequency band and 800 MHz low-frequency band) and two different mid-frequency bands (for example, 1800 MHz mid-frequency band and 2100 MHz mid-frequency band).

To achieve such multi-frequency band antennas in a commercially acceptable mode, a transverse spacing between the columns of the radiating element array may be reduced, such that the width of the base station antennas is maintained within an acceptable size range. Unfortunately, as adjacent columns are arranged closer together, the degree of signal coupling between adjacent columns may increase. For example, the coupling between the low-frequency band radiating elements or between the mid-frequency band radiating elements may increase. Such coupling makes the degree of isolation between adjacent columns worse, thereby possibly causing distortion of the antenna beams.

Some methods have been used to adjust the shape of the antenna beams. For example, a scheme using a lens is known. However, since the lens is typically arranged in front of the antenna array, the lens can cause interference with the main lobe of the antenna beams, thereby causing the distortion of the radiation pattern. Moreover, the lens may also adversely affect the return loss matching of the antenna, thereby increasing the difficulty of system matching. Still further, the lens is typically large in size and designed to cover the entire antenna array, so the lens occupies larger space between the antenna cover and the antenna array, which increases the volume and/or weight of the antenna to some extent, thereby affecting the wind-resistant load performance of the antenna.

### SUMMARY

According to a first aspect of the present disclosure, a base station antenna is provided, comprising: a reflective plate; a first column of first radiating elements comprising a plurality of first radiating elements arranged along a longitudinal direction; a second column of first radiating elements comprising a plurality of first radiating elements arranged along a longitudinal direction; at least one first decoupling metamaterial element positioned between the first column and the second column, the first decoupling metamaterial element being mounted behind radiators of the first radiating elements and configured to at least partially reduce coupling between the first column and the second column, wherein a major surface of the first decoupling metamaterial element is substantially parallel to a major surface of the reflective plate, wherein the first radiating elements are configured to operate within a first frequency band.

According to a second aspect of the present disclosure, a multi-frequency band antenna is provided, comprising: first radiating elements configured to operate within a first frequency band; second radiating elements configured to operate within a second frequency band, wherein the second frequency band is higher than the first frequency band; first decoupling metamaterial elements mounted behind radiators of the first radiating elements and in front of radiators of the second radiating elements, wherein the first decoupling metamaterial elements being configured to partially reflect rearward radiation from the first radiating elements, such that the reflected rearward radiation is redirected, wherein the redirected radiation from the first radiating elements is configured to at least partially offset coupling radiation between the adjacent first radiating elements.

According to a third aspect of the present disclosure, a multi-frequency band antenna is provided, comprising: a reflective plate; a first radiating element array comprising a first column and a second column which are adjacent and configured to operate within a first frequency band; a linear column of first decoupling metamaterial elements positioned between the first column and the second column, wherein the linear column of first decoupling metamaterial elements comprises a plurality of first decoupling metamaterial elements arranged along a longitudinal direction, wherein each first decoupling metamaterial element comprises passive resonant units arranged in a periodic order.

According to a fourth aspect of the present disclosure, a multi-frequency band antenna is provided, comprising: a reflective plate; first radiating elements configured to operate within a first frequency band; second radiating element configured to operate within a second frequency band, wherein the second frequency band is higher than the first frequency band; first decoupling metamaterial elements mounted behind radiators of the first radiating elements and in front of radiators of the second radiating elements; and second decoupling metamaterial elements mounted behind radiators of the second radiating elements, wherein a major surface of the second radiating elements and a major surface of the second decoupling metamaterial element are substantially parallel with a major surface of the reflective plate.

According to a fifth aspect of the present disclosure, a base station antenna is provided, comprising: a reflective plate; a plurality of first radiating elements configured to operate within a first frequency band; at least one first decoupling metamaterial element mounted between two adjacent first radiating elements, the first decoupling metamaterial elements being mounted behind radiators of the first radiating elements and partially reflecting rearward radiation from the first radiating elements, such that the reflected rearward radiation and coupling radiation between two adjacent first radiating elements are at least partially offset from one another, wherein a major surface of the first decoupling metamaterial elements is directed at an angle between —45° and 45° relative to a major surface of the reflective plate.

### BRIEF DESCRIPTION OF THE DRAWING

FIG. 1 to FIG. 3 show a schematic perspective view, a schematic front view and a schematic end view of a base station antenna according to a first example of the present disclosure, respectively.

FIG. 4 to FIG. 6 show a schematic perspective view, a schematic front view and a schematic end view of a base station antenna according to a second example of the present disclosure, respectively.

FIG. 7 to FIG. 9 show a schematic perspective view, a schematic front view and a schematic end view of a base station antenna according to a third example of the present disclosure, respectively.

FIG. 10 to FIG. 12 show a schematic perspective view, a schematic front view and a schematic end view of a base station antenna according to a fourth example of the present disclosure, respectively.

FIG. 13 to FIG. 15 show a schematic perspective view, a schematic front view and a schematic end view of a base station antenna according to a fifth example of the present disclosure, respectively.

FIG. 16 to FIG. 18 show a schematic perspective view, a schematic front view and a schematic end view of a base station antenna according to a sixth example of the present disclosure, respectively.

FIG. 19 to FIG. 21 show a schematic perspective view, a schematic front view and a schematic end view of a base station antenna according to a seventh example of the present disclosure, respectively.

FIG. 22 to FIG. 24 show a schematic perspective view, a schematic front view and a schematic end view of a base station antenna according to an eighth example of the present disclosure, respectively.

FIG. 25 to FIG. 27 show a schematic perspective view, a schematic front view and a schematic end view of a base station antenna according to a ninth example of the present disclosure, respectively.

FIG. 28 to FIG. 30 show a schematic perspective view, a schematic front view and a schematic end view of a base station antenna according to a tenth example of the present disclosure, respectively.

FIG. 31 to FIG. 33 show a schematic perspective view, a schematic front view and a schematic end view of a base station antenna according to an eleventh example of the present disclosure, respectively.

FIG. 34 and FIG. 35 show schematic diagrams of two exemplary decoupling metamaterial elements.

FIG. 36 and FIG. 37 show schematic diagrams of two additional exemplary decoupling metamaterial elements.

It should be noted that in the implementations described below, the same reference signs are sometimes used across different attached drawings to denote the same parts or parts with similar functions, and repeated descriptions thereof are omitted. In some cases, similar labels and letters are used to denote similar items. Therefore, once an item is defined in one attached drawing, there is no need for further discussion in subsequent attached drawings.

For ease of understanding, the position, dimension, and range of each structure shown in the attached drawings and the like may not indicate the actual position, dimension, and range. Therefore, the present disclosure is not limited to the position, size, range, etc. disclosed in the attached drawings.

### DETAILED DESCRIPTION

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional examples.

It should be understood that the terms used herein are only used to describe specific examples, and are not intended to limit the scope of the present disclosure. All terms used herein (including technical terms and scientific terms) have meanings normally understood by those skilled in the art unless otherwise defined. For the sake of brevity and/or clarity, well-known functions or structures may not be described in detail.

As used herein, when an element is said to be “on” another element, “attached” to another element, “connected” to another element, “coupled” to another element, or “in contact with” another element, etc., the element may be directly positioned on another element, attached to another element, connected to another element, coupled to another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. As used herein, when one feature is arranged “adjacent” to another feature, it may mean that one feature has a part overlapping with the adjacent feature or a part located above or below the adjacent feature.

In this specification, elements, nodes or features that are “connected” together may be mentioned. Unless explicitly stated otherwise, “connected” means that one element/node/feature can be mechanically, electrically, logically or otherwise connected with another element/node/feature in a direct or indirect manner to allow interaction, even though the two features may not be directly connected. That is, “connected” means direct and indirect connection of components or other features, including connection using one or more intermediate components.

As used herein, spatial relationship terms such as “upper”, “lower”, “left”, “right”, “front”, “back”, “high” and “low” can explain the relationship between one feature and another in the drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the term “exemplary” means “serving as an example, instance, or illustration”, rather than as a “model” to be precisely replicated. Any realization method described exemplarily herein may not be necessarily interpreted as being preferable or advantageous over other realization methods. Furthermore, the present disclosure is not limited by any expressed or implied theory given in the above technical field, background art, summary of the invention or specific embodiments.

As used herein, the word “basically” means including any minor changes caused by design or manufacturing defects, device or component tolerances, environmental influences, and/or other factors. The term “essentially” also allows for the divergence from the perfect or ideal situation due to parasitic effects, noise, and other practical considerations that may be present in the actual implementation.

In addition, for reference purposes only, “first,” “second,” and similar terms may also be used herein, and thus are not intended to be limiting. For example, unless explicitly stated in context, the use of words such as “first,” “second,” or other such numerical terms concerning structures or components does not imply any particular order or sequence.

It should also be understood that when the term “comprising/including” is used herein, it indicates the presence of the specified features, steps, operations, units, and/or components but does not exclude the presence or addition of one or more other features, steps, operations, units, and/or components, and/or combinations thereof.

The present application provides a base station antenna that adjusts a radiation pattern based on decoupling metamaterial elements. In the base station antenna, the decoupling metamaterial elements may be configured to be positioned between adjacent radiating elements and positioned behind radiators of these radiating elements, such that undesirable coupling interference between the adjacent radiating elements is reduced, thereby adjusting the radiation pattern. Since the decoupling metamaterial elements are positioned behind the radiators of the radiating elements, they may be configured to partially reflect rearward radiation from the radiating elements, such that the reflected rearward radiation and coupling radiation between the adjacent radiating elements are at least partially offset from one another, thereby effectively reducing distortion of the radiation pattern (mainly a main lobe) without affecting forward radiation substantially.

In the present disclosure, the decoupling metamaterial elements should be understood as a structure formed by metamaterials or including metamaterials for adjusting the RF performance of an antenna. The decoupling metamaterial elements may achieve adjustment of characteristics such as an electromagnetic wave propagation mode, polarization, amplitude, phase, etc. The properties of metamaterials stem from their precise geometric structure and size. In the present disclosure, metamaterials should be understood broadly, that is, metamaterials can include all periodic electromagnetic materials, such as frequency selective surfaces, electromagnetic band gap structures, metasurfaces, artificial magnetic conductors, photonic band gap structures, and surface plasmons, among others.

The base station antenna 100 according to some examples of the present disclosure will now be described in more detail with reference to the attached drawings. It should be noted that the base station antenna 100 may also have other components, and in order to avoid obscuring the main points of the present disclosure, the other components are not shown in the attached drawings and will not be discussed herein. It should also be noted that the drawings only schematically show the relative positional relationship of various components, and there is no particular limitation on the specific structure of each component.

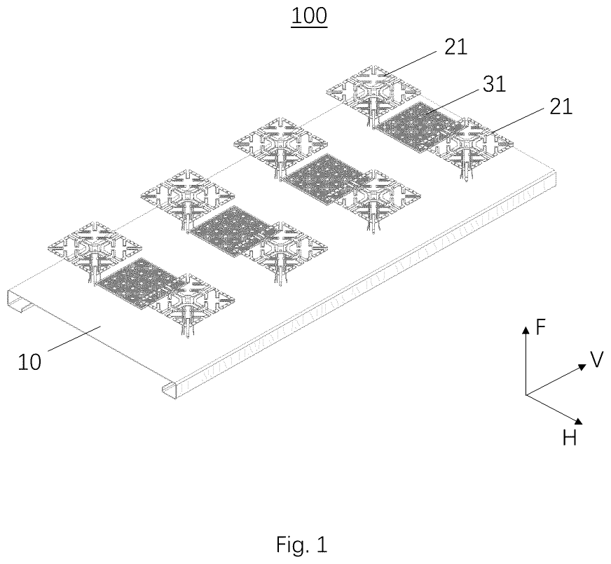

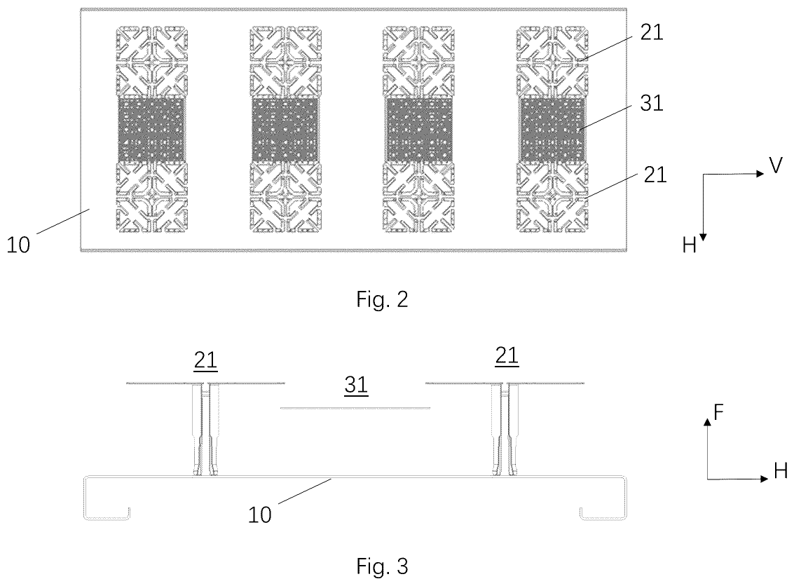

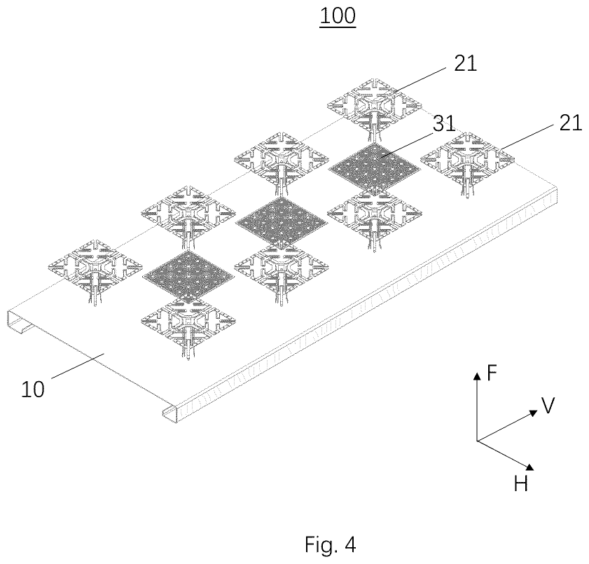

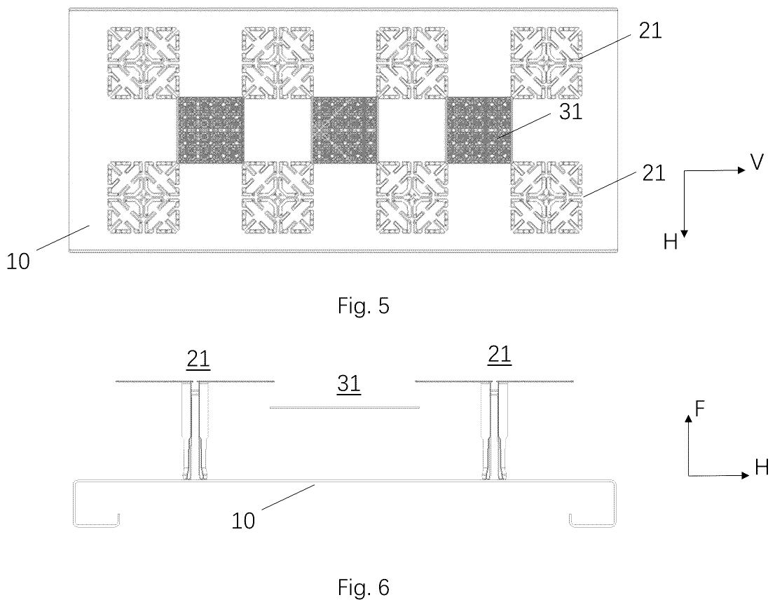

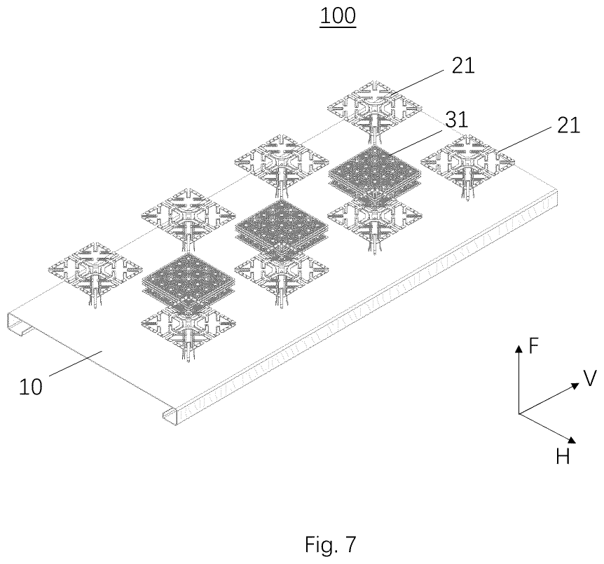

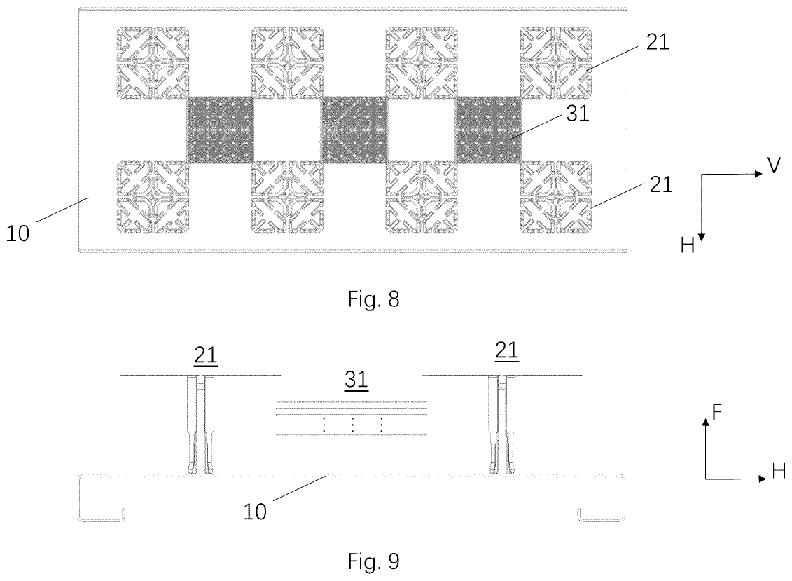

FIG. 1 to FIG. 3 show a schematic perspective view, a schematic front view and a schematic end view of a base station antenna 100 according to some examples of the present disclosure, respectively. FIG. 4 to FIG. 6 show a schematic perspective view, a schematic front view and a schematic end view of a base station antenna 100 according to some examples of the present disclosure, respectively. FIG. 7 to FIG. 9 show a schematic perspective view, a schematic front view and a schematic end view of a base station antenna 100 according to some examples of the present disclosure, respectively.

The base station antenna 100 usually includes an antenna cover (not shown) that provides environmental protection such as a radome. The base station antenna 100 may include a reflective plate 10, the reflective plate 10 may include a metallic major surface, and the metallic major surface provides a ground plane for radiating elements of a multi-column radiating element array and reflects electromagnetic radiation directed rearwardly from the radiating elements back in a forward direction. The base station antenna 100 may also include additional mechanical and electronic components, for example, one or more of connectors, cables, phase shifters, RET units, duplexers, etc., arranged on a rear side of the reflective plate 10.

The base station antenna 100 may include a plurality of first radiating elements arranged on a front side of the reflective plate 10. The first radiating elements 21 may be mounted to extend forwardly (i.e., in the forward direction F) from the reflective plate 10. The first radiating elements may include a plurality of columns of first radiating elements 21 (two columns in the figures for example), wherein each column of first radiating elements 21 may include a plurality of first radiating elements 21 arranged along a longitudinal direction or otherwise vertical direction V of the antenna. The first column and the second column may be spaced apart from one another in a horizontal direction H. The vertical direction V may be a direction of a longitudinal axis of the antenna or may be parallel to the longitudinal axis. The vertical direction V is perpendicular to the horizontal direction H and a forward direction F. As used herein, the term “vertical” does not necessarily require the object to be fully vertical (e.g., the antenna may have a small mechanical downdip). Each column of first radiating elements may be connected to an RF port of the antenna to form a linear array of first radiating elements. If dual-polarized first radiating elements are used, each column of radiating elements will be connected to two RF ports of the antenna (one for each polarization).

In some examples, an operating frequency band of the first radiating elements 21 may be, for example, 617-960 MHz or a sub-band thereof. In other words, the first radiating elements 21 may be configured as low-frequency band radiating elements that can operate within a first frequency band, for example 617-960 MHz or a sub-band thereof, and emit first electromagnetic radiation within the first frequency band. Depending on how the first radiating element 21 is fed, the two columns may be configured to form two separated first antenna beams (for each polarization) within the first frequency band, or may be configured to form a single antenna beam (for each polarization) within the first frequency band. It will be understood that arrangement schemes for the radiating element array may be diverse and not limited to the current examples. In some examples, the first radiating element array may have more or less columns of the first radiating elements 21. It should be understood that the operating frequency band of the first radiating element may be diverse and can be operated within the Sub-6 GHz band and not limited to the current examples. In some cases, the columns may form a multi-column beamforming array, with each column coupled to a port (or a pair of ports) of a beamforming radio.

The base station antenna 100 may also include at least one first decoupling metamaterial element 31 positioned between the first column and the second column, and the first decoupling metamaterial elements 31 may be mounted behind the radiators of the first radiating elements 21 and configured to at least partially reduce coupling between two side-by-side adjacent first radiating elements 21, thereby reducing the coupling between the first column and the second column. In some examples, a plurality of first decoupling metamaterial elements 31 that are spaced apart from each other may be mounted between the first column and the second column, and these first decoupling metamaterial elements 31 may be arranged into one linear column along the longitudinal direction. That is, the first column, the second column and the linear column of decoupling metamaterial elements therebetween are spaced apart from each other in the horizontal direction H and are parallel to each other. Thus, the coupling between the first column and the second column may be further reduced.

In some examples, the decoupling metamaterial elements 31, 32 described in the present application may be formed as or include passive resonant units arranged in a periodic order, such that a frequency selective surface or partially reflective surface is formed.

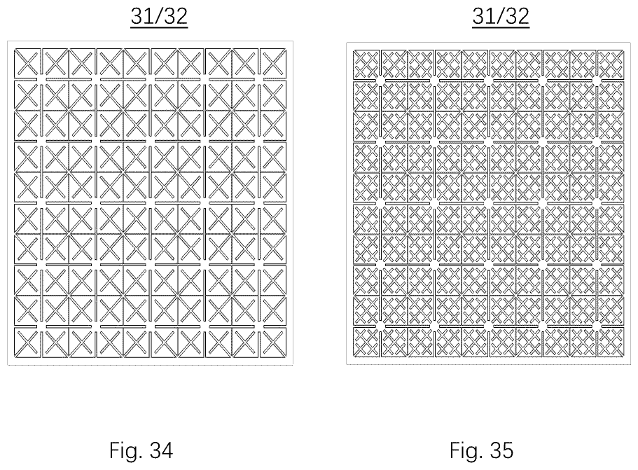

As shown in FIG. 34 and FIG. 35, two exemplary decoupling metamaterial elements are shown. The decoupling metamaterial elements 31, 32 may comprise printed circuit boards that have a dielectric substrate with passive resonant units printed thereon and arranged in a periodic order. In some examples, passive resonant units having one-dimensional cycles may be printed on the printed circuit boards. In some examples, passive resonant units having two-dimensional cycles may be printed on the printed circuit boards. In some examples, N-row M-column passive resonant units having two-dimensional cycles may be printed on the printed circuit boards, and N and M may be greater than or equal to 3, respectively. For example, 3*3 passive resonant units having two-dimensional cycles and 4*4 passive resonant units having two-dimensional cycles and the like. It should be understood that the decoupling metamaterial elements 31, 32 may alternatively be implemented as stamped metal plates, on which corresponding metal patterns may be formed. It is possible that the corresponding stamped metal plates may be fixed by means of a dielectric substrate.

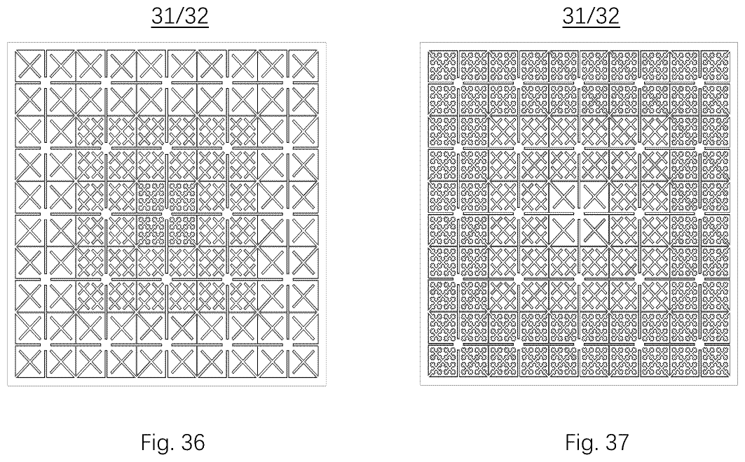

In some examples, as shown in FIG. 36 and FIG. 37, the decoupling metamaterial elements 31, 32 described in the present application may include different decoupling subregions, which may have different passive resonant unit patterns and/or passive resonant unit arrangement cycles. In some examples, each passive resonant unit may be designed into a fractal pattern unit, such that a compact size and broadband characteristics are obtained.

In some examples, a design scheme of the decoupling metamaterial elements 31, 32 described in the present application based on the passive resonant units arranged in a periodic order may be designed to be relatively compact. In particular, the size of each decoupling metamaterial element may be designed substantially equal to that of radiating elements relative to the lens covering the entire array. In some examples, a projected area of the first decoupling metamaterial elements 31 onto the reflective plate 10 may be between 80% and 120% of a projected area of the first radiating elements 21 on the reflective plate 10.

In some examples, as shown in FIG. 7 to FIG. 9, the decoupling metamaterial elements 31, 32 described in the present application may include multiple layers of printed circuit boards that overlap in the forward direction and passive resonant units that are printed on each layer of printed circuit board and arranged in a periodic order, respectively. In some examples, each layer of printed circuit boards may be spaced apart from each other by a distance in the forward direction. The decoupling metamaterial elements formed by the multiple layers of printed circuit boards may reflect the rearward radiation multiple times, such that an optimized offset effect is achieved. The decoupling metamaterial elements 31, 32 of the present disclosure may be mounted in front of the reflective plate 10 by way of a dielectric support structure (not shown).

Since the first decoupling metamaterial elements 31 are mounted rearwardly of radiators of the first radiating elements 21, the first decoupling metamaterial elements 31 do not substantially have an undesirable direct impact on the forward radiation or, in other words, main lobe radiation of the first radiating elements 21; and in the lens scheme, an undesirable direct impact may be caused as the lens is arranged directly in a forward radiation path. The present disclosure provides that the first decoupling metamaterial elements 31 are arranged directly in a rearward radiation path of the first radiating elements 21, such that a direct impact on the rearward radiation or rearward flap radiation of the first radiating elements 21 (which is not otherwise expected) may be caused, thereby indirectly modifying the distortion of the radiation pattern, for example, the main lobe thereof.

The rearward radiation of the first radiating elements 21 may be incident on the first decoupling metamaterial elements 31. The first decoupling metamaterial elements 31 may be configured to be partially reflective with respect to the electromagnetic radiation within the first frequency band. The first decoupling metamaterial elements 31 may be configured to partially reflect the rearward radiation from the first radiating elements 21, and the redirected rearward radiation may therefore change in aspects of a phase and/or a magnitude, thereby at least partially offsetting the coupling radiation between adjacent first radiating elements 21. That is, additional coupling may be formed between the first decoupling metamaterial elements 31 and the adjacent first radiating elements 21, which may be configured to at least partially offset the direct coupling between adjacent first radiating elements 21 in the first column and the second column, such that an optimized offset effect is achieved.

It will be understood that factors such as a height of the first decoupling metamaterial elements 31, a size of the first decoupling metamaterial elements 31, and reflective characteristics of the first decoupling metamaterial elements 31 may affect the phase and/or the magnitude of the redirected rearward radiation, thereby affecting the offset effect between the coupling radiation with the adjacent first radiating element 21. These factors may be adjusted based on actual application scenarios prior to the antenna being put into applications, such that an optimized offset effect is achieved.

To better receive the rearward radiation incident thereon, the major surface of the first decoupling metamaterial elements 31 may be substantially parallel to the major surface of the reflective plate 10. As a primary radiation surface of the radiators of the first radiating elements 21 is substantially parallel to the major surface of the reflective plate 10, the major surface of the first decoupling metamaterial elements 31 may be substantially parallel to the primary radiation surface of the radiators of the first radiating elements 21.

In other examples, due to the limitations of the mounting space or to improve the decoupling effect, the major surface of the first decoupling metamaterial elements 31 may also be oriented at an angle relative to the major surface of the reflective plate 10, e.g., oriented at an angle between −45° and 45°, or at an angle between −30° and 30°. In some examples, the major surface of the first decoupling metamaterial elements 31 may be formed as a type V, i.e., a first portion is oriented at a negative angle and a second portion is oriented at a positive angle.

In some examples, the first decoupling metamaterial elements 31 may be configured to partially vertically overlap with the radiators of the first radiating elements 21 positioned in front. That is, a forward projection of the first decoupling metamaterial elements 31 may partially overlap with a forward projection of the first radiating elements 21. “Vertical overlap” means that two or more objects form a stacked relationship in space with one object positioned directly above or directly below another object. As shown in FIG. 3, lateral edges of the first decoupling metamaterial elements 31 may vertically overlap with lateral edges of the radiators of the first radiating elements 21, and the vertical overlap arrangement mode may achieve a compact arrangement structure. Further, the vertical overlap arrangement mode may advantageously improve the decoupling effect of the first decoupling metamaterial elements 31.

In some examples, as shown in FIG. 1 to FIG. 3, the linear column of first decoupling metamaterial element 31 is aligned in arrangement relative to the first column and the second column. That is, the two side-by-side adjacent first radiating elements 21 and the first decoupling metamaterial elements 31 therebetween may be aligned in the horizontal direction H. Advantageously, one first decoupling metamaterial element 31 may be mounted between one first radiating element 21 in the first column and one adjacent first radiating element 21 in the second column, and the first decoupling metamaterial element 31 may be arranged substantially centrally in horizontal direction H between the two adjacent first radiating elements 21. The first decoupling metamaterial element 31 may partially vertically overlap with the first radiating element 21 in the first column at its first side and/or may partially vertically overlap with the first radiating element 21 in the second column at its second side in the horizontal direction H.

In some examples, as shown in FIG. 4 to FIG. 6, the linear column of first decoupling metamaterial elements 31 is staggered in arrangement relative to the first column and the second column. That is, the two side-by-side adjacent first radiating elements 21 may be staggered from the first decoupling metamaterial element 31 therebetween in the horizontal direction H. In some examples, the two adjacent first radiating elements 21 may also be staggered from one another. Advantageously, one first decoupling metamaterial element 31 may be mounted between two adjacent first radiating elements 21 in the first column and two adjacent first radiating elements 21 in the second column, and the first decoupling metamaterial element 31 is arranged substantially centrally in horizontal direction H between the four adjacent first radiating elements 21. The first decoupling metamaterial element 31 may partially vertically overlap with the two adjacent first radiating elements 21 in the first column at its first side and may partially vertically overlap with the two adjacent first radiating elements 21 in the second column at its second side in the horizontal direction H. Sharing one first decoupling metamaterial element 31 by four adjacent first radiating elements 21 may provide advantageous effects in terms of the antenna weight, volume, and/or cost.

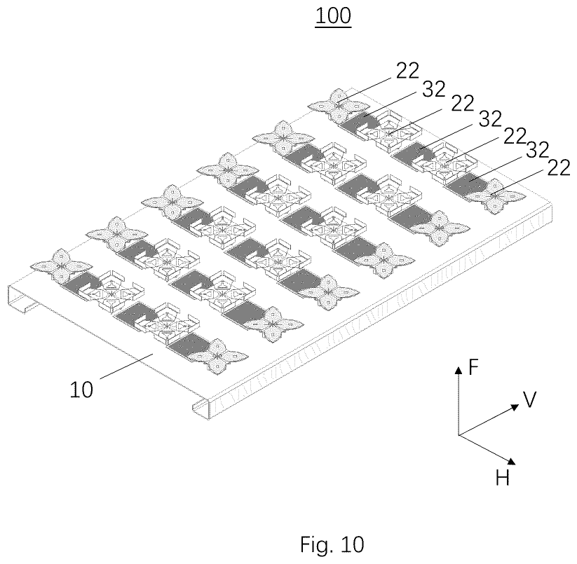

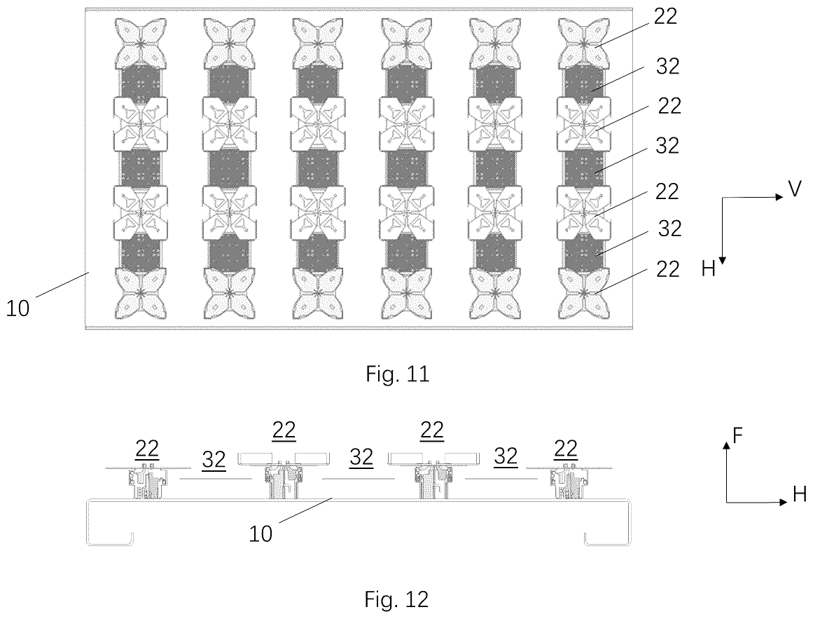

Referring to FIGS. 10-12, the base station antenna 100 may additionally or alternatively include one or more arrays of second radiating elements that are arranged on a front side of the reflective plate 10. The second radiating elements 22 may be mounted to extend forward from the reflective plate 10. In the depicted embodiment, four columns of second radiating elements 22 are provided, wherein each column of second radiating elements 22 may include a plurality of second radiating elements 22 arranged along a longitudinal direction or otherwise vertical direction V of the antenna. Each column is spaced apart from one another in the horizontal direction H.

In some examples, an operating frequency band of the second radiating elements 22 may be, for example, 1427-2690 MHz or a sub-band thereof. In other words, the second radiating elements 22, as mid-frequency band radiating elements, may be configured to be capable of operating within a second frequency band, for example 1427-2690 MHz or a sub-band thereof, and emit second electromagnetic radiation within the second frequency band. In some examples, a third column and/or a sixth column of second radiating elements 22 may be configured to operate within a first sub-band of the second frequency band, while a fourth column and/or a fifth column of second radiating element 22 may be configured to operate within a second sub-band of the second frequency band, wherein the first sub-band and the second sub-band may only partially overlap. It will be understood that arrangement schemes for the second radiating element array may be diverse and not limited to the current examples. In some examples, the second radiating element array may have more or less columns of second radiating elements 22.

The base station antenna 100 may also include at least one second decoupling metamaterial element 32 between the third column and the fourth column, and the second decoupling metamaterial elements 32 may be mounted behind the radiators of the second radiating elements 22 and configured to at least partially reduce coupling between two side-by-side adjacent second radiating elements 22, thereby reducing coupling between the third column and the fourth column. In some examples, a plurality of second decoupling metamaterial elements 32 spaced apart from each other may be mounted between the third column and the fourth column, and these second decoupling metamaterial elements 32 may be arranged into one linear column along the longitudinal direction. That is, the third column, the fourth column and the linear column of decoupling metamaterial elements therebetween are spaced apart from each other in the horizontal direction H in a mode of being parallel to each other. Thus, the coupling between the third column and the fourth column may be further reduced.

Additionally or alternatively, the base station antenna 100 may also include at least one second decoupling metamaterial element 32 between a fifth column and a sixth column, and the second decoupling metamaterial elements 32 may be mounted behind the radiators of the second radiating elements 22 and configured to at least partially reduce coupling between two side-by-side adjacent second radiating elements 22, thereby reducing coupling between the fifth column and the sixth column. In some examples, a plurality of second decoupling metamaterial elements 32 spaced apart from each other may be mounted between the fifth column and the sixth column, and these second decoupling metamaterial elements 32 may be arranged into one linear column along the longitudinal direction. That is, the fifth column, the sixth column and the linear column of decoupling metamaterial elements therebetween are spaced apart from each other in the horizontal direction H in a mode of being parallel to each other. Thus, the coupling between the fifth column and the sixth column may be further reduced.

Additionally or alternatively, the base station antenna 100 may also include at least one second decoupling metamaterial element 32 between a fourth column and a fifth column, and the second decoupling metamaterial elements 32 may be mounted behind the radiators of the second radiating elements 22 and configured to at least partially reduce coupling between two side-by-side adjacent second radiating elements 22, thereby reducing coupling between the fourth column and the fifth column. In some examples, a plurality of second decoupling metamaterial elements 32 spaced apart from each other may be mounted between the fourth column and the fifth column, and these second decoupling metamaterial elements 32 may be arranged in one linear column along the longitudinal direction. That is, the fourth column, the fifth column and the linear column of decoupling metamaterial elements therebetween are spaced apart from each other in the horizontal direction H in a mode of being parallel to each other. Thus, the coupling between the fourth column and the fifth column may be further reduced.

In some examples, as shown in FIG. 10 to FIG. 12, a column of second decoupling metamaterial elements 32 may be arranged between linear columns of adjacent second radiating elements 22, respectively. In particular, a first column of second decoupling metamaterial elements 32 is arranged between the third column and the fourth column, a second column of second decoupling metamaterial elements 32 is arranged between the fourth column and the fifth column, and a third column of second decoupling metamaterial elements 32 is arranged between the fifth column and the sixth column. Further, the linear column of the respective second decoupling metamaterial elements 32 may be aligned in arrangement relative to the linear columns of the second radiating elements 22. That is, the two side-by-side adjacent second radiating elements 22 and the second decoupling metamaterial elements 32 therebetween may be aligned in the horizontal direction H. Advantageously, the second decoupling metamaterial element 32 may be arranged substantially centrally in the horizontal direction H between two adjacent second radiating elements 22. The second decoupling metamaterial element 32 may partially vertically overlap with one second radiating element 22 at its first side and may partially vertically overlap with another adjacent second radiating element 22 at its second side in the horizontal direction H.

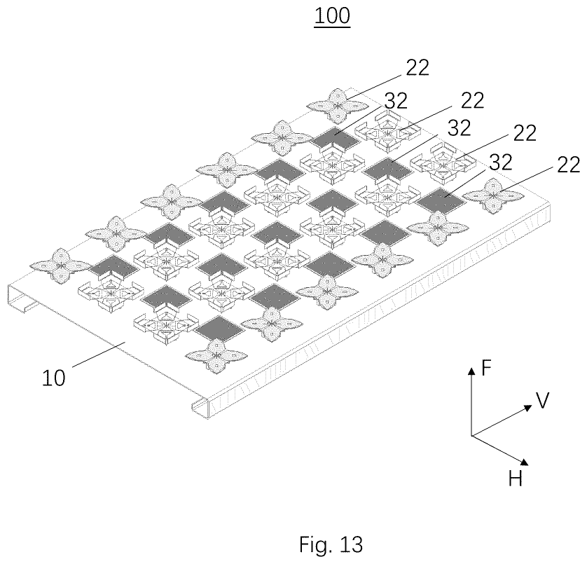

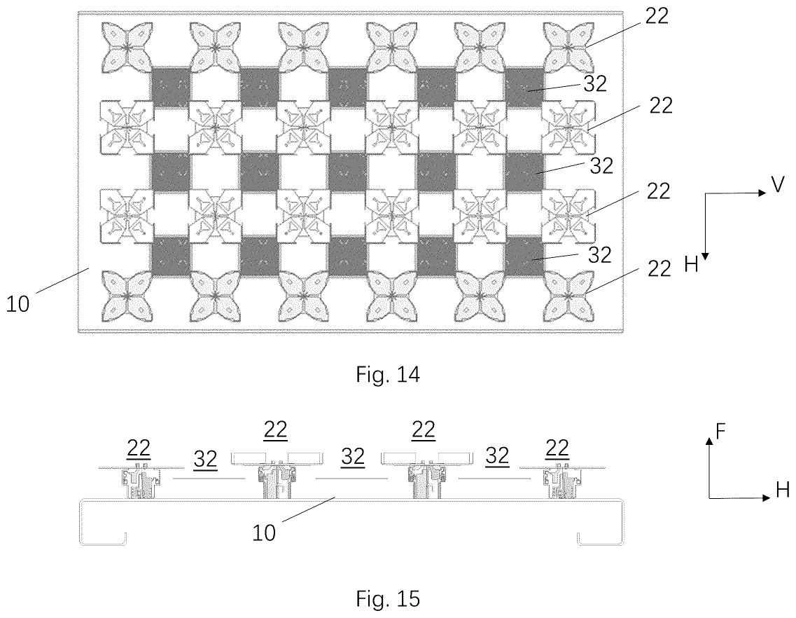

In some examples, as shown in FIG. 13 to FIG. 15, a column of second decoupling metamaterial elements 32 may be arranged between linear columns of adjacent second radiating elements 22, respectively. Further, a respective linear column of second decoupling metamaterial elements 32 may be staggered in arrangement relative to the linear column of second radiating elements 22. That is, the two side-by-side adjacent second radiating elements 22 may be staggered in the horizontal direction H with the second decoupling metamaterial element 32 therebetween. In some examples, the two adjacent second radiating elements 22 may also be staggered from one another. Advantageously, the second decoupling metamaterial element 32 may be arranged substantially centrally in the horizontal direction H between four adjacent second radiating elements 22. The second decoupling metamaterial element 32 may partially vertically overlap with the two adjacent second radiating elements 22 at its first side and may partially vertically overlap with the two additional adjacent second radiating elements 22 at its second side in the horizontal direction H. Sharing one second decoupling metamaterial element 32 by four adjacent second radiating elements 22 may provide advantageous effects in terms of the antenna weight, volume, and/or cost.

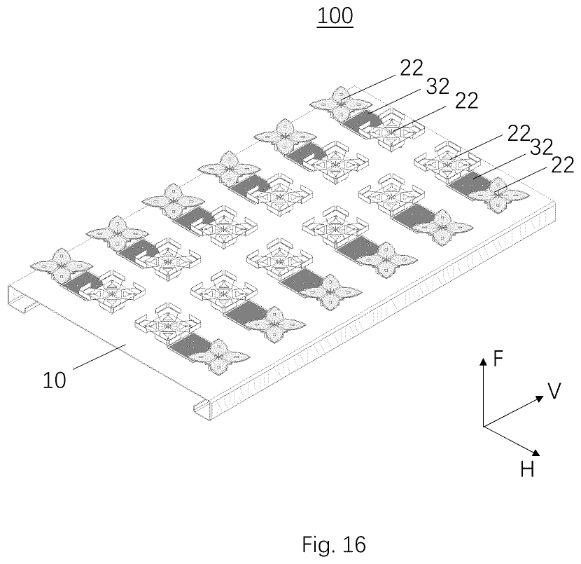

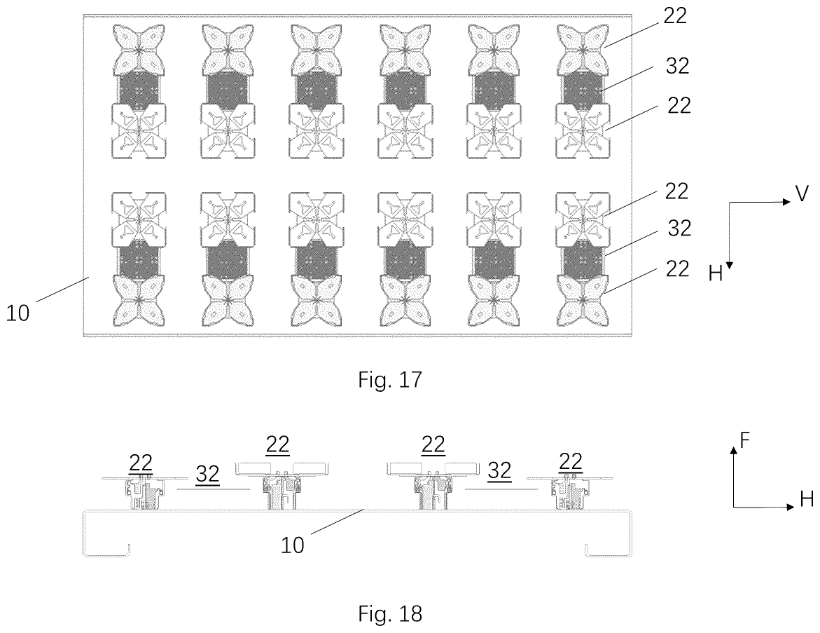

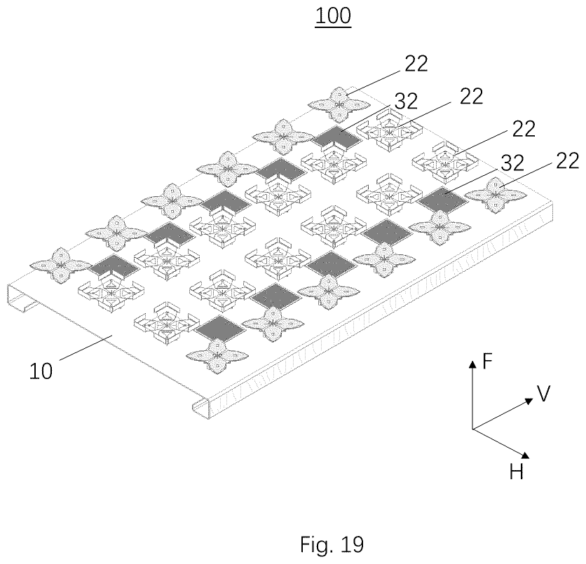

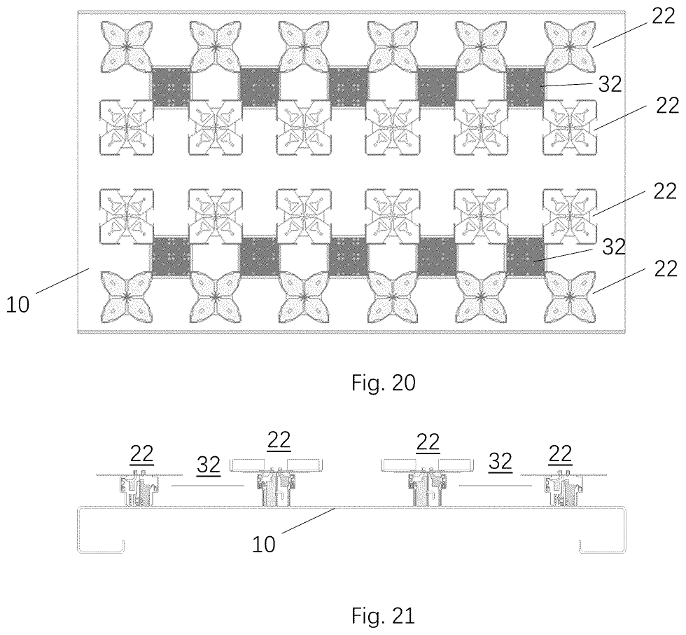

In some examples, as shown in FIG. 16 to FIG. 18 and as shown in FIG. 19 to FIG. 21, a column of second decoupling metamaterial elements 32 may be arranged between some linear columns of adjacent second radiating elements 22, and a column of second decoupling metamaterial elements 32 is not arranged between other linear columns of adjacent second radiating elements 22. In some examples, a first column of second decoupling metamaterial elements 32 may be arranged between the third column and the fourth column, a second column of second decoupling metamaterial elements 32 may be arranged between the fifth column and the sixth column, and no second decoupling metamaterial elements 32 are provided between the fourth column and the fifth column. Omitting a column of second decoupling metamaterial elements 32 may provide advantageous effects in terms of the antenna weight, volume, and/or cost. In some instances, the coupling interference between the fourth column and the fifth column may be within an acceptable range due to the selection of operating sub-bands and/or the spacing between them, thereby avoiding the need for an additional column of second decoupling metamaterial elements 32. In some examples, as shown in FIG. 16 to FIG. 18, the linear columns of the respective second decoupling metamaterial elements 32 may be aligned in arrangement relative to the linear columns of the second radiating elements 22. In some examples, as shown in FIG. 19 to FIG. 21, the linear columns of the respective second decoupling metamaterial elements 32 may be staggered in arrangement relative to the linear columns of the second radiating elements 22.

Description of the second decoupling metamaterial elements 32 may refer to the above description of the decoupling metamaterial elements as well as the first decoupling metamaterial elements 31.

Since the second decoupling metamaterial elements 32 are mounted behind the radiators of the second radiating elements 22, the second decoupling metamaterial elements 32 do not substantially have an undesirable direct impact on the forward radiation or, in other words, the main lobe radiation of the second radiating elements 22. The present disclosure provides that the second decoupling metamaterial elements 32 are arranged directly in a rearward radiation path, such that a direct impact on the rearward radiation or rearward flap radiation of the second radiating elements 22 (which is not otherwise expected) may be caused, thereby indirectly modifying the distortion of the radiation pattern, for example, the main lobe thereof.

The rearward radiation of the second radiating elements 22 may be incident on the second decoupling metamaterial element 32. The second decoupling metamaterial elements 32 may be configured to be partially reflective with respect to the electromagnetic radiation within the second frequency band. The second decoupling metamaterial elements 32 may be configured to partially reflect the rearward radiation from the second radiating elements 22, and the redirected rearward radiation may therefore change in aspects of a phase and/or a magnitude, thereby at least partially offsetting the coupling radiation between adjacent second radiating elements 22. That is, additional coupling may be formed between the second decoupling metamaterial elements 32 and the adjacent second radiating elements 22, which may be configured to at least partially offset the coupling formed between adjacent second radiating elements 22 in two adjacent columns, such that an optimized offset effect is achieved.

It will be understood that factors such as a height of the second decoupling metamaterial elements 32, a size of the second decoupling metamaterial elements 32, and reflective characteristics of the second decoupling metamaterial elements 32 may affect the phase and/or the magnitude of the redirected rearward radiation, thereby affecting the offset effect between the coupling radiation with the adjacent second radiating elements 22. These factors may be adjusted based on actual application scenes prior to the antenna being put into applications, such that an optimized offset effect is achieved.

To better receive the rearward radiation incident thereon, the major surface of the second decoupling metamaterial elements 32 may be substantially parallel to the major surface of the reflective plate 10. As a primary radiation surface of the radiators of the second radiating elements 22 is substantially parallel to the major surface of the reflective plate 10, the major surface of the second decoupling metamaterial elements 32 may be substantially parallel to the primary radiation surface of the radiators of the second radiating elements 22.

In other examples, due to the limitations of the mounting space or to improve the decoupling effect, the major surface of the second decoupling metamaterial elements 32 may also be oriented at an angle relative to the major surface of the reflective plate 10, e.g., oriented at an angle between −45° and 45°, or at an angle between −30° and 30°. In some examples, the major surface of the second decoupling metamaterial elements 32 may be formed as a type V, i.e., a first portion is oriented at a negative angle and a second portion is oriented at a positive angle.

In some examples, the second decoupling metamaterial elements 32 may be configured to partially vertically overlap with the radiators of the second radiating elements 22 positioned in front. That is, a forward projection of the second decoupling metamaterial elements 32 may partially vertically overlap with a forward projection of the second radiating elements 22. This vertical overlapping arrangement mode may achieve a compact arrangement structure. Further, the vertical overlap arrangement mode may advantageously improve the decoupling effect of the second decoupling metamaterial elements 32.

Next, an exemplary example of the multi-frequency band antenna 100 according to the present disclosure is described in detail. The multi-frequency band antenna 100 may include a first radiating element array and a second radiating element array. The first radiating element array may include a plurality of columns of first radiating elements 21, for example, two columns of first radiating elements 21 (referred to above as a first column and a second column), and an operating frequency band of the first radiating elements 21 may be, for example, 617-960 MHz or a sub-band thereof. The second radiating element array may include a plurality of columns of second radiating elements 22, for example, four columns of second radiating elements 22 (hereinafter referred to as a third column, a fourth column, a fifth column and a sixth column), and an operating frequency band of the second radiating elements 22 may be, for example, 1427-2690 MHz or a sub-band thereof. Additionally or alternatively, the multi-frequency band antenna 100 may further comprise a third radiating element array not shown, the third radiating element array may include a plurality of columns of third radiating elements, and an operating frequency band of the third radiating elements may be, for example, 3.1-4.2 GHz or a sub-band thereof.

To achieve a compact structure, the first radiating elements 21 may at least partially cover the second radiating elements 22, such that the axis perpendicular to the reflective plate 10 intersects the first radiating elements 21 and the second radiating elements 22 (i.e., the first radiating elements 21 and the second radiating elements 22 at least partially vertically overlap in the forward direction F). In order to reduce a scattering effect of the first radiating elements 21 on the radiation pattern generated by the second radiating elements 22, the first radiating elements 21 are configured to have a cloaking function for the second radiating element 22, and the cloaking function may be generated through a resonant structure integrated on a radiator of the first radiating elements 21. For example, radiating arms of the radiators of the first radiating elements 21 may be designed as cloaked radiating arms, which may include narrow sections and wide sections, respectively. The narrow sections and the wide sections may form at least one resonant structure that is configured to at least partially attenuate currents within at least part of the frequency range of the mid-frequency band that could otherwise be induced on the radiating arm itself.

The multi-frequency band antenna 100 may include at least one first decoupling metamaterial element 31, for example, one linear column of first decoupling metamaterial elements 31, between the first column and the second column; at least one second decoupling metamaterial elements 32, for example, a first linear column of the second decoupling metamaterial element 32, between the third column and the fourth column; at least one second decoupling metamaterial element 32, for example, a second linear column of the second decoupling metamaterial elements 32, between the fifth column and the sixth column; and where possible, at least one second decoupling metamaterial element 32, for example, a third linear column of the second decoupling metamaterial element 32, between the fourth column and the fifth column.

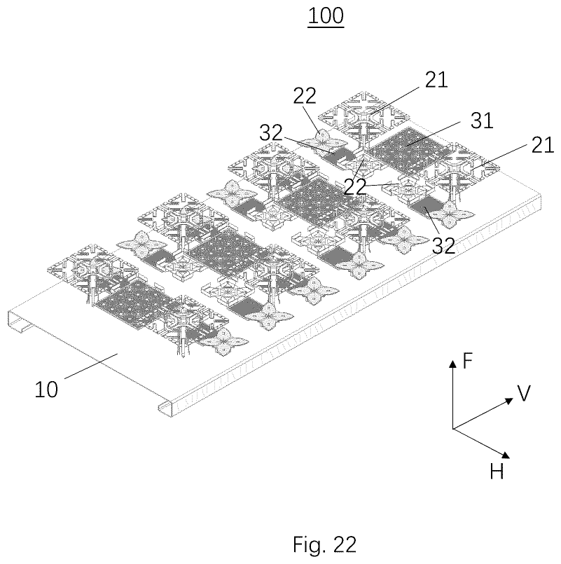

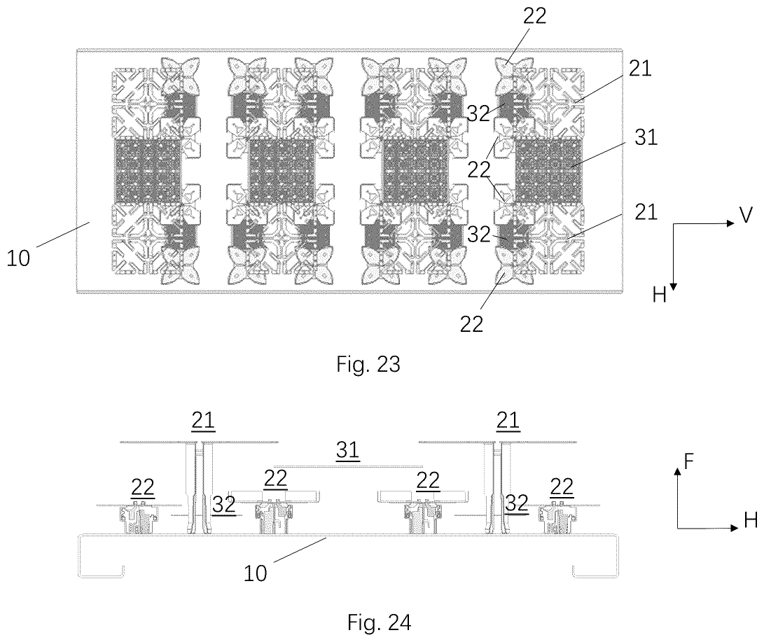

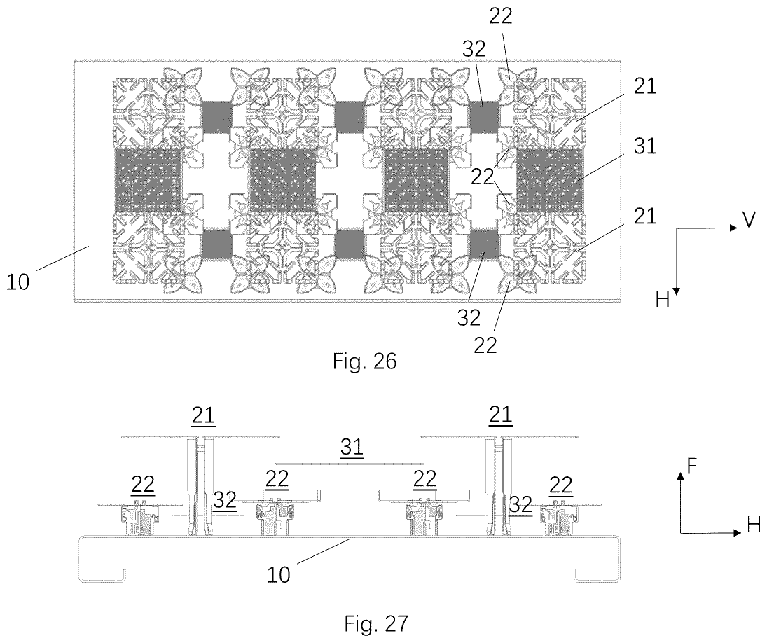

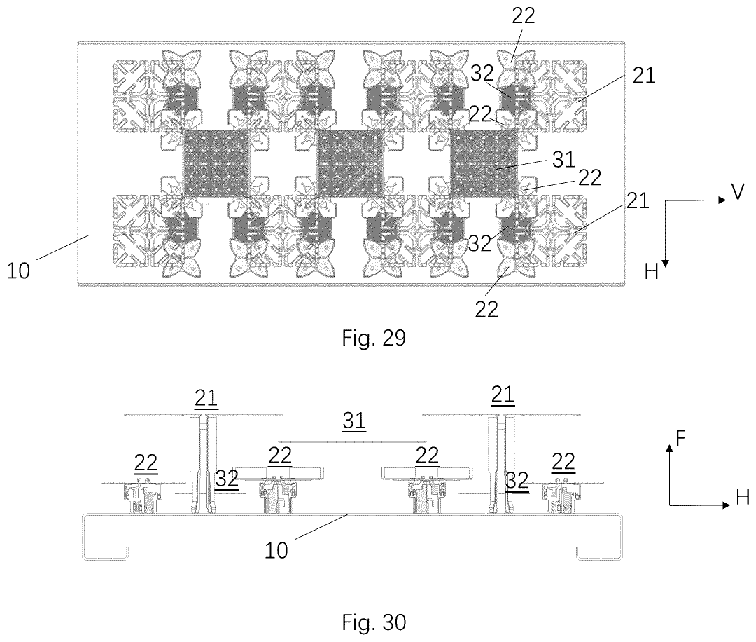

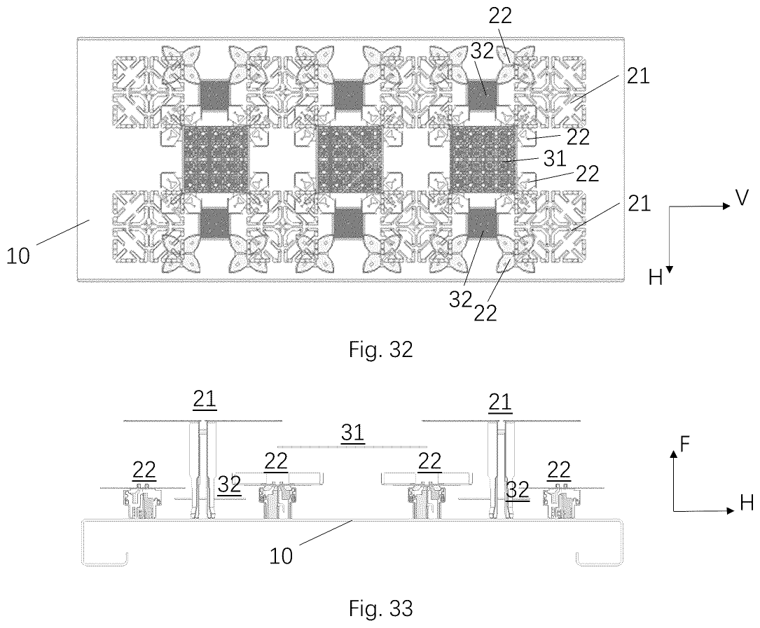

As shown in FIG. 22 to FIG. 33, the first decoupling metamaterial elements 31 may be mounted behind the radiators of the first radiating elements 21 and in front of the radiators of the second radiating elements 22. In other words, the first decoupling metamaterial elements 31 are between the radiators of the first radiating elements 21 and the radiators of the second radiating elements 22 in the forward direction. The second decoupling metamaterial elements 32 may be mounted behind the radiators of the second radiating elements 22. The first decoupling metamaterial elements 31 may be configured to partially vertically overlap with the radiators of the first radiating elements 21 positioned forwardly and the radiators of the second radiating elements 22 positioned rearwardly.

In some examples, the first decoupling metamaterial elements 31 and the second decoupling metamaterial elements 32 may be designed as passive resonant units arranged in a periodic order, thereby achieving a compact structure. Typically, the size of each decoupling metamaterial element may be designed to be substantially equal to that of the mated radiating elements. In some examples, a projected area of the first decoupling metamaterial elements 31 may be between 80% and 120% of a projected area of the first radiating elements 21. A projected area of the second decoupling metamaterial element 32 may be between 80% and 120% of a projected area of the second radiating elements 22. Accordingly, the size of the first decoupling metamaterial element 31 is larger than the size of the second decoupling metamaterial element 32, e.g., the size of the first decoupling metamaterial element 31 is at least twice the size of the second decoupling metamaterial element 32.

In order to reduce or otherwise avoid the effect of the first decoupling metamaterial elements 31 in the forward radiation of the second radiating elements 22, the first decoupling metamaterial elements 31 may be configured to be substantially invisible to the electromagnetic radiation within the second frequency band, such that forward radiation energy from the second radiating elements 22 is substantially transmitted through the first decoupling metamaterial elements 31. In other words, the electromagnetic radiation within the second frequency band may be transmitted through the first decoupling metamaterial elements 31 for the vast majority (e.g., 90%, 95%, or more than 99%), thereby substantially not affecting the forward radiation of the second radiating elements 22.

In order to reduce or otherwise avoid the effect of the second decoupling metamaterial elements 32 on the rearward radiation of the first radiating elements 21, the second decoupling metamaterial element 32 may be configured to be substantially invisible to the electromagnetic radiation within the first frequency band, such that rearward radiation energy from the first radiating elements 21 is substantially transmitted through the second decoupling metamaterial elements 32. In other words, the electromagnetic radiation within the first frequency band may be transmitted through the second decoupling metamaterial elements 32 for the vast majority (e.g., 90%, 95%, or more than 99%), thereby substantially not affecting the rearward radiation of the first radiating elements 21.

Additionally or alternatively, as the second decoupling metamaterial elements 32 are also behind the radiators of the first radiating elements 21, and more specifically behind the first decoupling metamaterial elements 31, the second decoupling metamaterial elements 32 may also be configured to at least partially reflect the rearward radiation from the first radiating elements 21, such that the reflected rearward radiation is redirected so as to achieve an optimized offset effect.

In some examples, as shown in FIG. 22 to FIG. 24, the linear columns of the first decoupling metamaterial elements 31 are aligned in arrangement relative to the linear columns of the respective first radiating elements 21, and the linear columns of the second decoupling metamaterial elements 32 are aligned in arrangement relative to the linear columns of the respective second radiating elements 22.

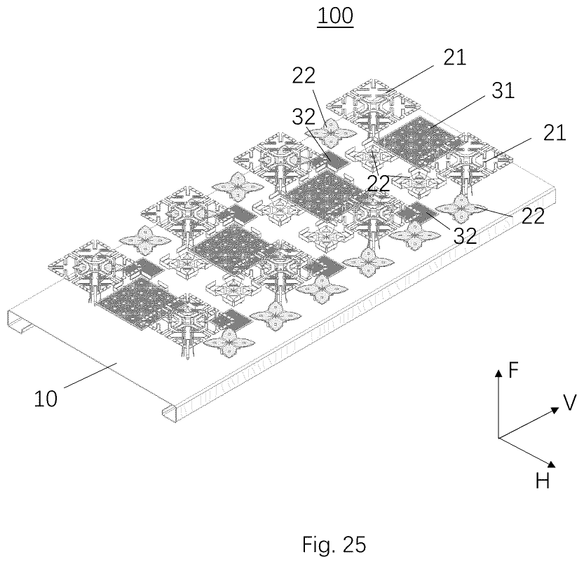

In some examples, as shown in FIG. 25 to FIG. 27, the linear columns of the first decoupling metamaterial elements 31 are aligned in arrangement relative to the linear columns of the respective first radiating elements 21, and the linear columns of the second decoupling metamaterial elements 32 are staggered in arrangement relative to the linear columns of the respective second radiating elements 22.

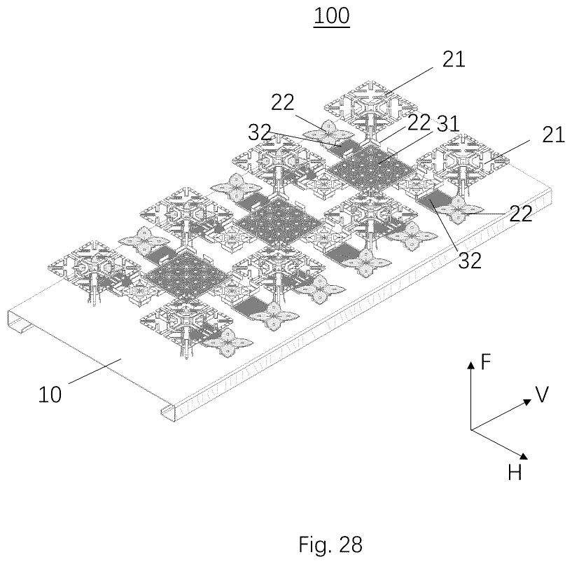

In some examples, as shown in FIG. 28 to FIG. 30, the linear columns of the first decoupling metamaterial elements 31 are staggered in arrangement relative to the linear columns of the respective first radiating elements 21, and the linear columns of the second decoupling metamaterial elements 32 are aligned in arrangement relative to the linear columns of the respective second radiating elements 22.

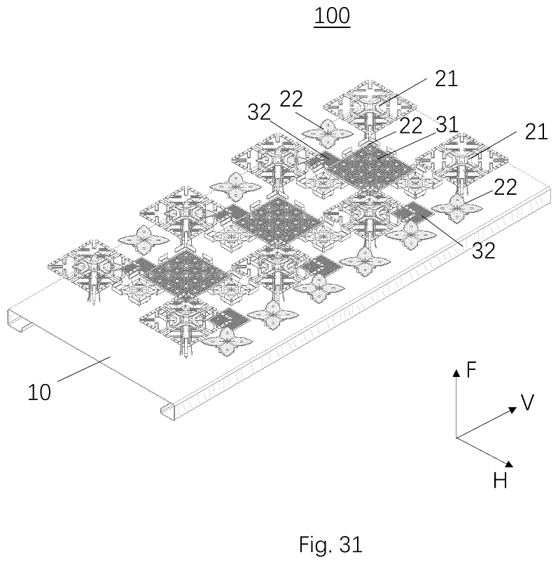

In some examples, as shown in FIG. 31 to FIG. 33, the linear columns of the first decoupling metamaterial elements 31 are staggered in arrangement relative to the linear columns of the respective first radiating elements 21, and the linear columns of the second decoupling metamaterial elements 32 are staggered in arrangement relative to the linear columns of the respective second radiating elements 22.

It will be understood that the respective decoupling metamaterial elements can be arranged in a flexible manner, which can be adapted depending on a particular mounting environment and/or commissioning structure.

Although some specific examples of the present disclosure have been described in detail by embodiments, those skilled in the art should understand that the above embodiments are only for illustration, not for limiting the scope of the present disclosure. The examples disclosed herein can be combined arbitrarily without departing from the spirit and scope of the present disclosure. Those skilled in the art should also understand that various modifications can be made to the examples without departing from the scope and spirit of the present disclosure. The scope of the present disclosure is defined by the attached claims.

1. A base station antenna, comprising:
a reflective plate;
a first column of first radiating elements comprising a plurality of first radiating elements arranged along a longitudinal direction;
a second column of first radiating elements comprising a plurality of first radiating elements arranged along the longitudinal direction;
at least one first decoupling metamaterial element positioned between the first column and the second column, the first decoupling metamaterial elements being mounted behind radiators of the first radiating elements and configured to at least partially reduce coupling between the first column and the second column, wherein a major surface of the first decoupling metamaterial element is substantially parallel to a major surface of the reflective plate,
wherein the first radiating elements are configured to operate within a first frequency band.

2. The base station antenna according to claim 1, wherein the base station antenna comprises a plurality of first decoupling metamaterial elements spaced apart from one another between the first column and the second column.

3. The base station antenna according to claim 2, wherein the plurality of first decoupling metamaterial elements is arranged into one linear column along the longitudinal direction.

4. The base station antenna according to claim 1, wherein the first decoupling metamaterial elements are configured to partially vertically overlap with the radiators of the first radiating elements positioned in front.

5. The base station antenna according to claim 3, wherein the linear column of first decoupling metamaterial elements is aligned in arrangement relative to the first column and the second column.

6. The base station antenna according to claim 5, wherein each first decoupling metamaterial element is arranged substantially centrally in a horizontal direction between two adjacent first radiating elements in the first column and the second column.

7. The base station antenna according to claim 5, wherein each first decoupling metamaterial element partially vertically overlaps with the first radiating element in the first column at its first side and partially vertically overlaps with the first radiating element in the second column at its second side in the horizontal direction.

8. The base station antenna according to claim 3, wherein the linear column of first decoupling metamaterial elements is staggered in arrangement relative to the first column and the second column.

9. The base station antenna according to claim 8, wherein each first decoupling metamaterial element is arranged substantially centrally in the horizontal direction between four adjacent first radiating elements in the first column and the second column.

10. (canceled)

11. The base station antenna according to claim 1, wherein the base station antenna further comprises:
a third column of second radiating elements comprising a plurality of second radiating elements arranged along the longitudinal direction;
a fourth column of second radiating elements comprising a plurality of second radiating elements arranged along the longitudinal direction;
at least one second decoupling metamaterial element positioned between the third column and the fourth column, the second decoupling metamaterial elements being mounted behind radiators of the second radiating elements and configured to at least partially reduce coupling between the third column and the fourth column,
wherein the second radiating elements are configured to operate within a second frequency band, wherein the second frequency band is higher than the first frequency band.

12-15. (canceled)

16. The base station antenna according to claim 11, wherein the base station antenna comprises a plurality of second decoupling metamaterial elements spaced apart from one another between the third column and the fourth column.

17-32. (canceled)

33. The base station antenna according to claim 11, wherein
the second decoupling metamaterial elements are configured to be substantially invisible to electromagnetic radiation within the first frequency band, such that rearward radiation energy from the first radiating elements is transmitted substantially through the second decoupling metamaterial elements.
the second decoupling metamaterial elements are configured to at least partially reflect rearward radiation from the first radiating elements, such that the reflected rearward radiation is redirected.

34. A multi-frequency band antenna, comprising:
first radiating elements configured to operate within a first frequency band;
second radiating elements configured to operate within a second frequency band, wherein the second frequency band is higher than the first frequency band;
first decoupling metamaterial elements mounted behind radiators of the first radiating elements and in front of radiators of the second radiating elements, wherein the first decoupling metamaterial elements being configured to partially reflect rearward radiation from the first radiating elements, such that the reflected rearward radiation is redirected, wherein the redirected radiation from the first radiating elements is configured to at least partially offset coupling radiation between the adjacent first radiating elements.

35. The multi-frequency band antenna according to claim 34, wherein the first decoupling metamaterial elements are configured to be substantially invisible to the electromagnetic radiation within the second frequency band, such that forward radiation energy from the second radiating elements is transmitted substantially through the first decoupling metamaterial elements.

36. The multi-frequency band antenna according to claim 34, wherein the multi-frequency band antenna further comprises second decoupling metamaterial elements mounted behind radiators of the second radiating elements, wherein the second decoupling metamaterial elements are configured to partially reflect rearward radiation from the second radiating elements, such that the reflected rearward radiation is redirected.

37. The multi-frequency band antenna according to claim 36, wherein the redirected radiation from the second radiating elements is configured to at least partially offset coupling radiation between the adjacent second radiating elements.

38. The multi-frequency band antenna according to claim 36, wherein
the first decoupling metamaterial elements are configured to partially vertically overlap with the first radiating elements and the second radiating elements;
the second decoupling metamaterial elements are configured to partially vertically overlap with the second radiating elements, or the second decoupling metamaterial elements are configured to partially vertically overlap with the first radiating elements and the second radiating elements.

39-49. (canceled)

50. A multi-frequency band antenna, comprising:
a reflective plate;
first radiating elements configured to operate within a first frequency band;
second radiating elements configured to operate within a second frequency band, wherein the second frequency band is higher than the first frequency band;
first decoupling metamaterial elements mounted behind radiators of the first radiating elements and in front of radiators of the second radiating elements.
second decoupling metamaterial elements mounted behind the radiators of the second radiating elements,
wherein a major surface of the first decoupling metamaterial elements and a major surface of the second decoupling metamaterial elements are substantially parallel with a major surface of the reflective plate.

51. The multi-frequency band antenna according to claim 50, wherein
the first decoupling metamaterial elements are configured to partially vertically overlap with the first radiating elements and the second radiating elements;
the second decoupling metamaterial elements are configured to partially vertically overlap with the second radiating elements or with the first radiating elements and the second radiating elements.

52-54. (canceled)

55. The multi-frequency band antenna according to claim 50, wherein the first decoupling metamaterial elements and/or the second decoupling metamaterial elements comprise first decoupling sub-areas and second decoupling sub-areas, respectively, wherein the first decoupling sub-areas and the second decoupling sub-areas have different passive resonant unit patterns and/or passive resonant unit arrangement periods.

56-57. (canceled)
